(19) United States
(12) Patent Application Publication
(10) Pub. No.: US 2018/0064281 A1
(43) Pub. Date: Mar. 8, 2018

(54) SELF COOKING KITCHEN APPLIANCE

(71) Applicant: James G. Collins, Evans, GA (US)

(72) Inventor: James G. Collins, Evans, GA (US)

(21) Appl. No.: 15/694,769

(22) Filed: Sep. 2, 2017

Related U.S. Application Data
(60) Provisional application No. 62/383,100, filed on Sep. 2, 2016.

(51) Int. Cl. A47J 27/00; A23L 5/10; A47J 27/10

(52) U.S. Cl. CPC A47J 27/004; A23V 2002/00; A47J 27/10; A23L 5/10

(57) ABSTRACT

A cooking appliance comprising a cooking receptacle comprising a bottom and a continuous sidewall defining a cooking chamber having an open top end; a heating element positioned for providing heat to the cooking chamber; at least a food manipulator r(FM) operably mounted in the cooking receptacle; an appliance drive unit (ADU) operably connected to the FM s; and a controller circuit including a programmable controller positioned within the housing and operatively associated with said control panel, said circuit being configured to cause the heating element to operate in a plurality of heating and a plurality of cooking modes and to allow a user to set cooking time and temperature and motion of the FM.

### PRIORITY APPLICATION

This application claims priority to U.S. Provisional Application Ser. No. 62/383,100, filed Sep. 2, 2016, the disclosure of which is incorporated herein in its entirety by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings, that form a part of this document: Copyright 2017-Culinary Kraft LLC, ALL RIGHTS RESERVED

### TECHNICAL FIELD

This document generally relates to methods and systems for an appliance for cooking food.

### OVERVIEW

The present solution is a multicooker that takes food items placed in its receptacle, generally in an unprepared state (i.e., raw frozen, direct from package format), holds them at a desired temperature, (i.e. frozen, food safe temperature, defrosted or cooked) transforms the food from the unprepared state by selectively, defrosting, reducing the food size from unprepared state to prepared state s by sizing via cleaving or shearing the food and dispersing heat as needed to elevate the food temperature to a desired level and then hold the food at a food safe temperature (heated or chilled) until removed from the processing receptacle.

### BRIEF DESCRIPTION OF THE DRAWINGS

For the ease of the review, the reader may identify the discussion of any particular element or act by referencing the most significant digit or digits in a reference number refer to the figure number in which that element is first introduced.

FIG. 1 illustrates an exterior aspect of the cooking appliance subject matter in accordance with some solutions.

FIG. 2 illustrates a detail aspect of the cooking appliance subject matter in accordance with some solutions.

FIG. 3 illustrates a detail aspect of the cooking appliance apparatus in accordance with some solutions.

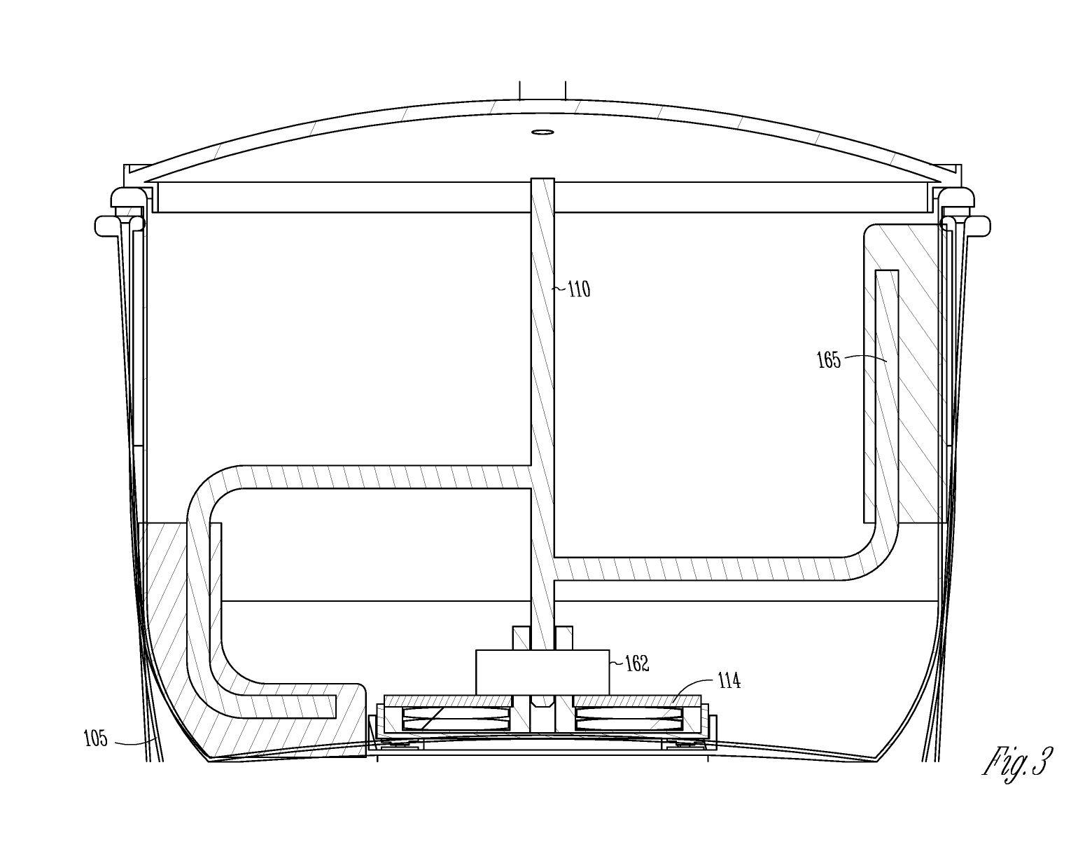

FIG. 4 illustrates a detail aspect of the cooking appliance apparatus in accordance with some solutions.

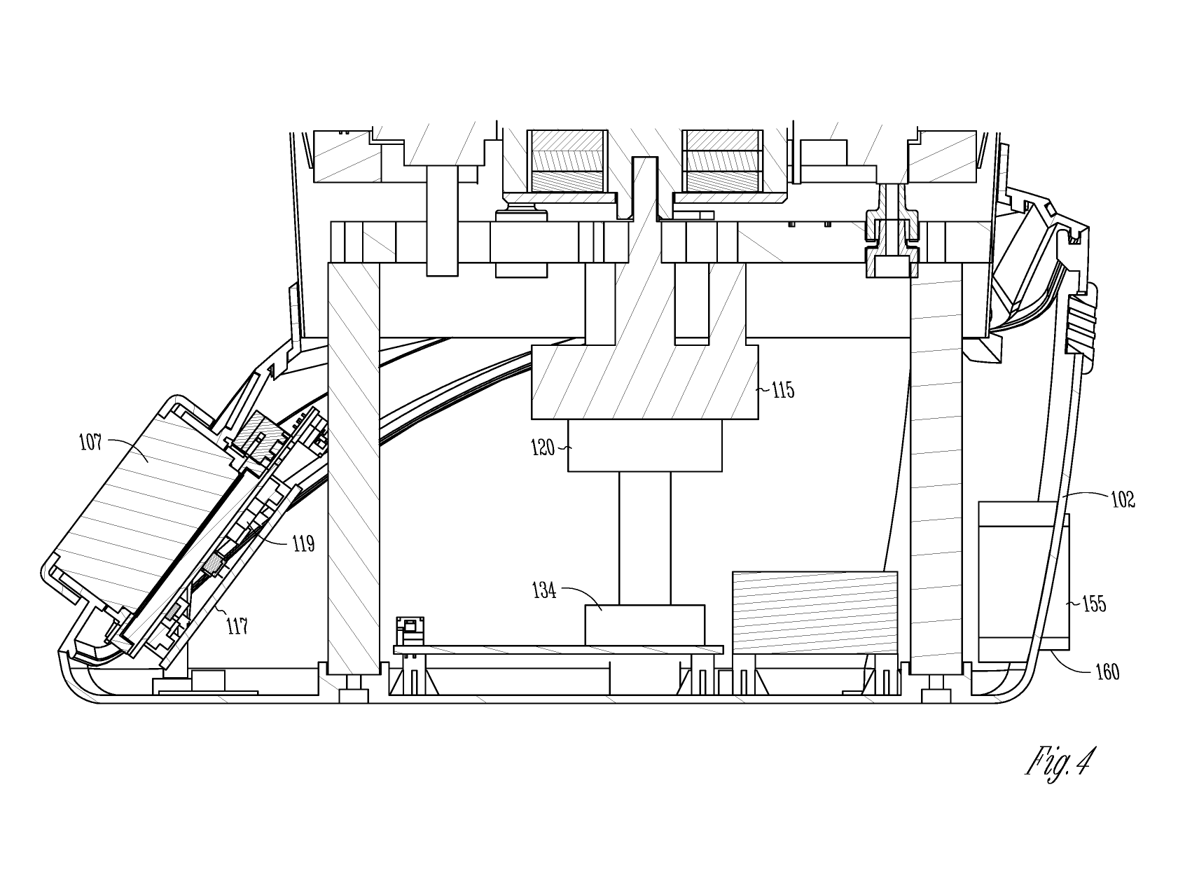

FIG. 5 illustrates an aspect of the cooking appliance food manipulator arms in accordance with some solutions.

FIG. 6 illustrates an aspect of the cooking appliance food manipulator arms in accordance with some solutions

FIG. 7 illustrates an aspect of the cooking appliance food manipulator arms in accordance with some solutions.

FIG. 8 illustrates an aspect of the cooking appliance food manipulator arms in accordance with some solutions

FIG. 9 illustrates an process aspect of the cooking appliance food operations in accordance with some solutions

### DETAILED DESCRIPTION

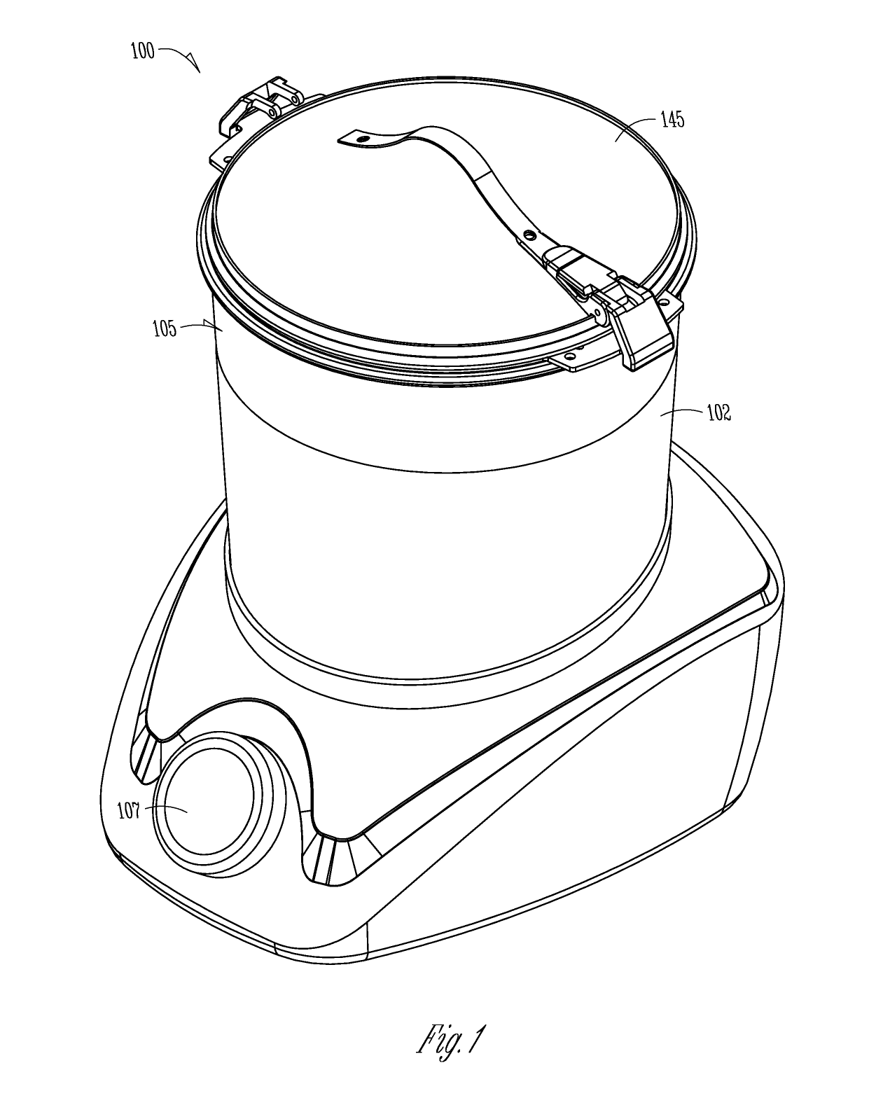

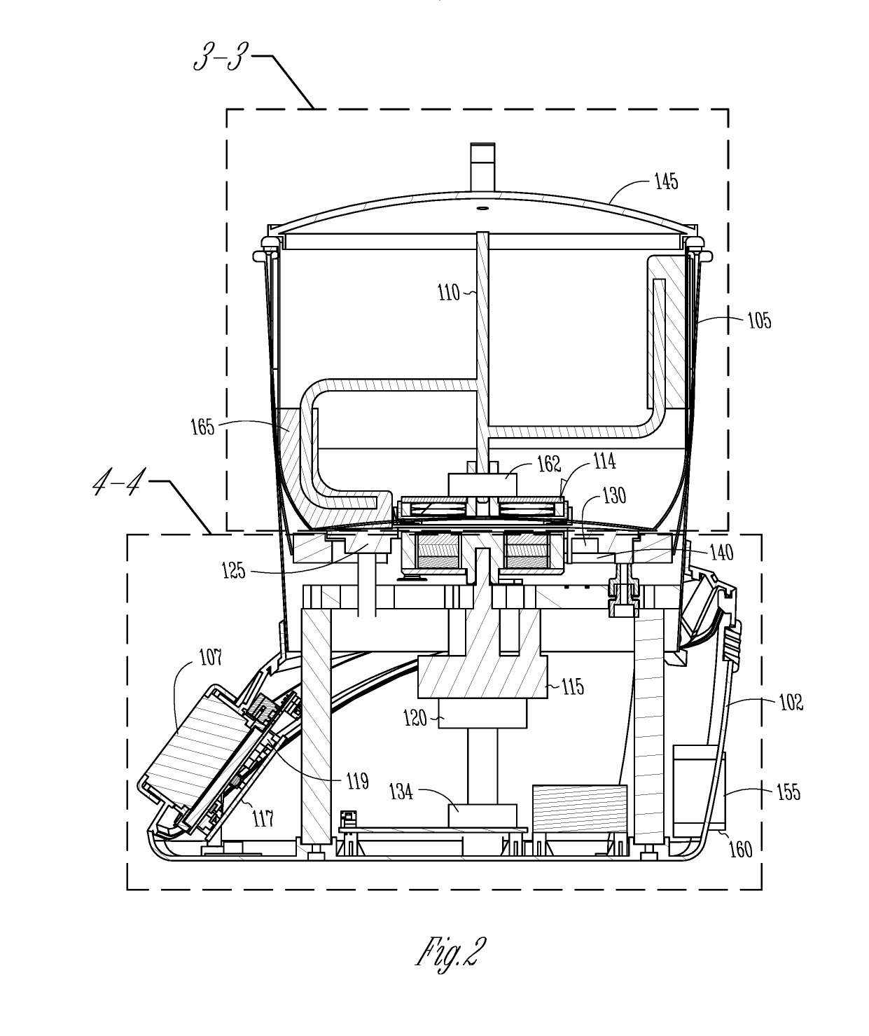

As can be seen generally in FIG. 1. And FIG. 2., the solution 100 comprises a housing 102 and a cooking receptacle 105 removably set in the housing 102 with at least a moveable food manipulator (FM) 110 that is releasably attached using a magnetic hub assembly 114 to an appliance drive unit (ADU) 115 that will move the FM 110 in a pattern inside of the cooking receptacle 105. The ADU 115 comprises a motor 120 that can additionally comprise a torque converter to allow the ADU 115 to operably increase or decrease speed and operably increase or decrease the force that the FM 110 can be moved through the food. In this example of the solution, the FM 110 is moved using magnetic or electromagnetic force via the magnetic hub assembly 114. The FM 110 is intended to be changed based on the type of food that is being prepared.

The housing 102 also will also include a heating element 125 that is operably capable of heating the cooking receptacle 105, thereby heating the food inside the cooking receptacle 105 to a desired temperature. This desired cooking temperature may range from a range of temperatures between 100 degrees Fahrenheit to 500 degrees Fahrenheit.

The housing 102 will, in some examples of the invention, also have a cooling element 130 allowing the cooking receptacle 105 to maintain at least a food safe temperature of 20 to 40 degrees Fahrenheit on the food in the cooking receptacle 105 during a preparatory or post cooking phase segment of time. The cooling element 130 can be implemented using refrigeration heat pump technology, absorption refrigeration Peltier effect cooling or magnetic refrigeration technologies. Peltier cooling is a thermoelectric effect is the direct conversion of cooking parameter differences to electric voltage and vice versa. A thermoelectric device creates voltage when there is a different temperature on each side. Conversely, when a voltage is applied to it, it creates a temperature difference. At the atomic scale, an applied temperature gradient causes charge carriers in the material to diffuse from the hot side to the cold side. This effect can be used to generate electricity, measure temperature or change the temperature of objects. Because the direction of heating and cooling is determined by the polarity of the applied voltage, thermoelectric devices can be used as temperature controllers. The term “thermoelectric effect” encompasses three separately identified effects: the Seebeck effect, Peltier effect, and Thomson effect. The effect may also be referred as the Peltier-Seebeck effect. The Peltier effect is the presence of heating or cooling at an electrified junction of two different conductors. When a current is made to flow through a junction between two conductors, A and B, heat may be generated or removed at the junction. The Peltier heat generated at the junction per unit time. A typical Peltier heat pump device involves multiple junctions in series, through which a current is driven. Some of the junctions lose heat due to the Peltier effect, while others gain heat. Thermoelectric heat pumps exploit this phenomenon, as do thermoelectric cooling devices found in refrigerators.

Vibration Cooking Cycle
The housing 102 in some examples will also have a vibration element 140 attached to the cooking receptacle 105 that will be used to detach any attached food particles and to help move larger food particles to be addressed by the FM 110. This is a complementary cooking cycle (e.g., loosening stuck or attached food particle with an included vibration cycle) intended to be intermittently utilized with the other cooking cycles. In this solution 100, the cooking receptacle 105 includes a vibration element 140 that creates a vibration cycle that would occur at the very beginning of the cooking cycle in both ground meat mode and/or sauté mode. This would occur at the very beginning of the cooking cycle (or similarly at the very end of the mixing/stirring mode) to function to settle all food products ensuring even distribution on the cooking surface. This vibration cycle would be to serve the same function of shaking a frying pan or a cooking pot.

The ADU 115 is controlled by a controller circuit (CC) 117 that directs the speed, pattern, movement and force application of the FM 110 via changing the speed, direction and force commands given to the FM 110 by a user's input. The housing 102 also comprises a cover 145 that operably seals the cooking receptacle 105 and prevents food pieces from leaving the cooking receptacle 105. Electrical power is supplied to the ADU 115 and its components via conventional electrical power connections including wired and wireless power transmission means. The power connection 155 will also include a safety (e.g., magnetic disconnect mechanism) mechanism 160 to allow emergency decoupling of a wired power transmission means. Additionally, the cooking receptacle 105 will have at least a sensor unit 162 that provides at least a temperature, speed, direction or force feedback measurement value to the CC 117 to allow the CC 117 to adjust the addressable food parameters such as temperature, consistency, heat distribution, among others. The sensor unit return measurement from unique sensors like a force sensor 134 or alternatively receive a number of sensed inputs from different components of the solution to reach a combined sensor feedback for the cooking appliance to utilize. The solution 100 has a multifunction user interactive knob 107 that allows the user to select a series of controllable features through a series of discreet actions. These features comprise the following commands or prompts.

All Cooking Modes

a. Turn on/off the entire device

b. Turn cooker to Warming mode or different cooking parameter setting on demand

c. Current temperature

d. Cooking alerts
i. Cooking temperature reached
ii. Cooking interrupted (Mechanical or Power Interruption
iii. Warming Temperature maintained
iv. Food Defrosted
v. Device Jam
vi. Food Not Ready for Cooking
vii. Cooking complete
viii. Food Chill On/Off
ix. Food Chill Temperature Set

e. FM Movement
i. Change direction or cycle of movement
ii. Stutter or move periodically
iii. Move based on food conditions

The CC has an optional feature a wireless communication module 119 that allows Internet of Things (Web enabled) interactivity with a computing device app which allows a user interaction with the solution 100 remotely.

### I) Solution Component Examples: ADU Examples

The solution comprises several ADU 115 examples that use different linkage methods to transfer torque to a FM 110:

1) Mechanical linkage: a mechanical link between to an appliance ADU 115 using mechanically delivered torque to drive at least a FM 110 within the cooking receptacle 105. This category includes hybrid mechanical solutions that could utilize other sources of power transmission (e.g., fluid transmission of force) to the FM 110.

2) Magnetic Linkage: a magnetic or electromagnetic force linkage using magnetic force to drive torque to drive at least a FM 110 within the cooking receptacle 105. Depending on the example of the solution 100, ADU 115 can utilize mechanical and non-mechanical torque and speed conversion methods to allow the FM 110 in the solution 100 to be driven at a variable number of speeds and torques to allow the solution 100 to drive at least a single FM 110 and manipulate several food types in several pre-processed, processed and final states.

### II) Solution Component Examples: Cooking Receptacles

The solution 100 also comprises several cooking receptacles 105 that support other examples of FM 110. The solution 100 includes a removable cooking receptacle 105 with various mounting components.
a. Center mount example—with a centrally located hole in the bottom center of the cooking receptacle 105 through which a connection to a FM 110 is made.
   i. This will be constructed of a lightweight, but durable metal and the cooking surface will be coated with a non-stick material.
   ii. This will be used for the following cooking applications:
      1. Ground meat
      2. Sauté
      3. Delicate Food Cooking
b. Cooking receptacle flowable foods example—A cooking receptacle 105 without a central opening in the bottom of the cooking receptacle 105 for linking to the FM 110. In this case, a FM 110 will be driven using a non-mechanical connection to the ADU 155.
   i. This will be constructed of a lightweight, but durable metal and the cooking surface will be coated with a non-stick material.
   ii. This will used for several cooking modes including:
      1. Sous Vide
      2. Slow Cooking
      3. Flowable foods including soups, chili, sauces and stews
      4. Deep flyer
      5. Delicate Food Cooking
Sous-vide is a method of cooking in which food is sealed in airtight plastic bags then placed in a water bath or in a temperature-controlled steam environment for longer than normal cooking times—96 hours or more, in some cases—at an accurately regulated temperature much lower than normally used for cooking, typically around 55° C. (131° F.) to 60° C. (140° F.) for meat and higher for vegetables

### III) Web-Enabled Cooking Operation:

The solution 100 comprises a web-enabled cooking operation. An example of utilization would include the solution sending a message to the user on a mobile app that will inform the operator that the cooking cycle has completed or is near to completion with designated time intervals prior to completion. The web-enabled system accesses sensor unit 162 in the cooking receptacle 105 and/or the FM 110s

Wireless Communication Mode (IOT)

The wireless communication module 119 is arranged within the CC 117, is coupled to the sensor unit 162, and transmits a unique identifier and a value corresponding to an output of the sensor unit 162 to an external computing device. Generally, the wireless communication module 119 functions to communicate a cooking parameter collected locally at the solution 100 to the remote computing device for further processing and to triggering delivery of cooking-related instructions to/from a user.

The wireless communication module 119 can transmit (and receive) data to (and from) the external computing device over short-range wireless communication protocol, such as over Bluetooth or Wi-Fi. For example, the wireless communication module 119 can broadcast the unique identifier, sensor unit 162, related data, and/or other local data via a radio antenna arranged within the housing 102. The wireless communication module 119 can also interface with one or more intermediate communication nodes, such as IEEE 802.11 Wi-Fi including an access point or IEEE 802.14.5 Zigbee within a mesh network. The wireless communication module 119 can alternatively communicate with the external computing device over alternate communication channels, such as via encoded infrared transmission. However, the wireless communication module 119 can communicate with the external computing device over any other suitable wireless communication standard or protocol.

In one TOT example, the wireless communication module 119 is operable between a first mode and a second mode. In the first mode, the wireless communication module 119 broadcasts a unique identifier at a first rate, such as at a static rate of twenty times per second (20 Hz). The unique identifier can be a static serial number assigned to the wireless communication module 119 or to the solution 100, a static wireless address assigned to the wireless communication module 119 or to the solution 100, or any other static value stored locally on and/or assigned to the wireless communication module 119 or to the solution 100 to enable the external computing device to wirelessly pair with the wireless communication module 119 within the solution 100. Alternatively, the wireless communication module 119 can broadcast a universally unique identifier (“UUID”), such as including a string of characters (e.g., a 128-bt hexadecimal number) in which the string of characters is practically unique (i.e., not guaranteed unique; the external computing device can then access a local or remote domain name system (“DNS”) to identify the solution 100. As described below, the method—executing on the external computing device—can trigger the computing device to pair with the wireless communication module 119 upon receipt of the unique identifier, such as based on a strength of the received signal. In a similar TOT example, the wireless communication module 119 can broadcast a pairing request or a beacon signal to advertise the presence of the solution 100 to a local external computing device in the first mode, and the wireless communication module 119 can broadcast the unique identifier once a pairing process is initiated between the solution 100 and the external computing device. Once the wireless communication module 119 of the solution 100 is thus paired with the external computing device, the wireless communication module 119 can transition into the second mode.

In the second mode, the wireless communication module 119 can broadcast—at a second rate—a value corresponding to a substantially current output of the sensor unit 162. For example, the wireless communication module 119 can broadcast values corresponding to outputs of the sensor unit 162 at a rate corresponding to the sampling rate of the sensor unit 162, such as at a second rate (e.g., 1 Hz) less than the first rate (e.g., 20 Hz). In the second mode, the wireless communication module 119 can broadcast a digital form of a raw sensor unit 162 reading, a calibrated or normalized form of the sensor unit 162 reading, (e.g., calculated temperature change rates, and/or indicators of detected cooking parameter events (e.g., transitions across specified cooking parameter thresholds), etc.—paired with the unique identifier or other identifier of the wireless communication module 119 or the solution 100—to the remote computing device.

In the example of the solution 100 that includes a force sensor 134, the wireless communication module 119 can additionally or alternatively transmit—to the external computing device—a third value corresponding to an output of the force sensor 134 corresponding to the force sensed at the FM 110. For example, in the second mode, the sensor unit 162 can sample the force sensor 134 and then transform this analog force sensor value into a digital value, and the wireless communication module 119 can transmit this (third) digital value to the external computing device along with an output of the sensor unit 162 recorded at approximately the same time as the output of the force sensor 134. Alternatively, the sensor unit 162 can sample the force sensor 134, and, in the second mode, the wireless communication module 119 can broadcast the third value corresponding to the output of the force sensor 134 at a rate other than the transmission rate of the (first) value of the sensor unit 162 output.

The wireless communication module 119 can also receive a command or data from the paired external computing device, such as a command to set an operational alert on or near the knob 107 arranged on the solution 100. The wireless communication module 119 is powered by the solutions 100 power source, as described above, or in any other suitable way.

In any case, the wireless communication module 119 can function in any other way establish a wireless connection to an external computing device (e.g., in the first mode) and to wirelessly communicate cooking parameters, timer, and/or any other relevant data to the external computing device (e.g., in the second mode).

Modes of Web-Enabled Operation—examples of controllable cooking parameters to be sensed and reported to a user's device

A. All Cooking Modes
a. Turn on/off the entire device
b. Turn cooker to Warming mode or different cooking parameter setting on demand
c. Alerts
d. Current temperature
e. Internal cooking alerts
   i. Cooking temperature reached
   ii. Cooking interrupted (Mechanical or Power Interruption)
   iii. Warming Temperature maintained
   iv. Food Defrosted
   v. Device Jam
   vi. Food Not Ready for Cooking
   vii. Cooking complete
   viii. Food Chill On/Off
   ix. Food Chill Temperature Set
f. FM Movement
   i. Change direction or cycle of movement
   ii. Stutter or move periodically
   iii. Move based on food conditions

### IV) Examples of Food Manipulator (FM) Actions and Cooking Modes

a. Sauté cooking of food items: The sauté FM (SFM) functions will comprise:
   i. Scraping vegetables/tofu from the interior bottom and sides of the cooking receptacle 105
   ii. Mixing/flipping the subject food within the cooking receptacle 105
   iii. This sauté mode will consist of cycles that will cook and mix/flip in specified durations and/or revolutions and speed
b. Ground meat cooking—
   i. Shearing raw or partially frozen meat to ensure breaking it up into smaller crumbles/pellets
   ii. The ground meat cooking mode will consist of variable cycles that will cook and mix/shear the food in specified durations and/or revolutions and speed
c. Delicate items cooking (e.g., items like Scrambled Eggs) The delicate item cooking functions will comprise:
   i. Stirring/mixing/blending eggs to provide an automated form of cooking scrambled eggs. The cooking cycle in this mode will consist of heating and stirring, both that will be continuous and occur simultaneously and RPM (See Table 1).
   ii. The delicate item cooking includes a continuous scraping mode of the interior walls to keep delicate items from sticking to the interior wall perimeters of the cooking receptacle.
d. Example of cooking flowable foods: Flowable foods comprise sous vide cooking, liquids, soups, chili, sauces and stews. Its movement functions include:
   i. Continuous stirring at a specified speed
   ii. Interval stirring which will consist of several preprogrammed cycles, each that will consist of cooking and stirring of specified durations and/or revolutions and speed.
   iii. Continuous management of liquid cooking solutions (e.g., sous vide cooking)
   iv.

Examples of Cooking and Agitation Times

| FOOD/ | | COOKING | AGITATION | TOTAL |
|---|---|---|---|---|
| MODE | TEMP. | CYCLE | CYCLE | COOK TIME |
| Ground | 160-220° F. | 15-60 sec. | 1-10 revs. | As specified |
| Beef | | | and/or | by food |
| | | | 2-30 sec. | temperature |
| Ground | 145-200° F. | 15-60 sec. | 1-10 revs. | 5-60 min. |
| Pork | | | and/or | |
| | | | 2-30 sec. | |
| Ground | 165-200° F. | 15-60 sec. | 1-10 revs. | 5-60 min. |
| Chicken | | | and/or | |
| | | | 2-30 sec. | |
| Sauté | 140-400° F. | 5-60 sec. | 1-10 revs. | Subjective |
| | | | and/or | to recipe |
| | | | 2-30 sec. | |
| Risotto | 140-400° F. | 5 sec. - | 1-10 revs. | Subjective |
| | | continuous | and/or | to recipe |
| | | | 2-30 sec. | |
| Pasta | 160-250° F. | 30 sec.- | 0.5-10 | Subjective |
| | | 4 min. | revs, and/or | to recipe |
| | | | 2-30 sec. | |
| Scrambled | 160-200° F. | Continuous | Continuous | |
| eggs | | | | |
| Risotto | 140-400° F. | 5 sec.- | 1-10 revs. | Subjective |
| | | continuous | and/or | to recipe |
| | | | 2-30 sec. | |
| Soup/ | 100-400° F. | 1 min. - | 30 sec. - | |
| Sauce | | 30 min. | 30 min. | |
| Oatmeal | 100-450° F. | 1 min. - | 30 sec. - | Subjective |
| | | 30 min. | 30 min. | to recipe |
| Yogurt | 100-300° F. | 1 min. - | 30 sec. - | Subjective |
| | | 30 min. | 30 min. | to recipe |

Food Manipulator (FM Examples)

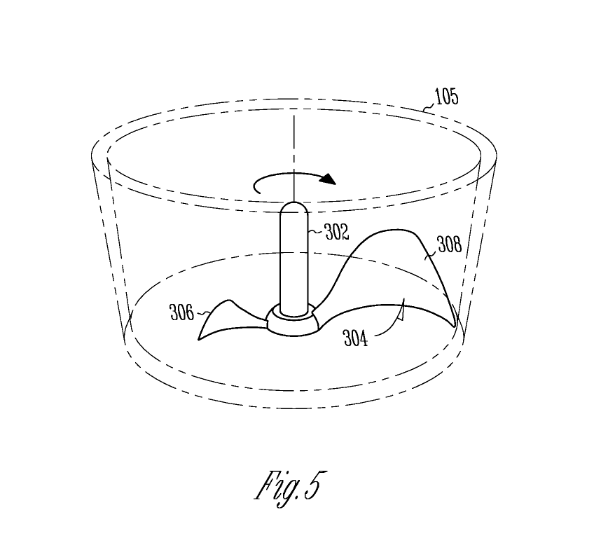

In FIG. 5-8 several FM examples are shown. Each example of FM will provide a different function when attached to the cooking receptacle 105. The general design of each FM 110 will comprise at least a single FM arm (FMA) 165. The FMA 165 will move food being processed between the inner wall perimeter of the cooking receptacle 105 and the center of the cooking receptacle 105. Each FM 110 is designed to function differently with the food type in which it will cook. Additionally, where an FM 110 has more than one FMA 165, each FMA 165 can have separate operations to either shear, manipulate, scrape and perform with one FMA 165 while the second FMA 165 performs a second and unique task
In FIG. 5., the sauté food manipulator (SFM) 302 is shown. In this instance of the solution, the SFM 302 has a double arm configuration, a lifting arm (LFMA) 304 for lifting the food and folding FM arm (FFMA) 306 for folding the food being cooked. The SFM 302 utilizes each arm (304 and 306) to alternately lift and fold the food being cooked. As mentioned previously, the SFM 302 also can be presented in the current solution with a set of FM heating elements 308 (see description of inductive heating) are embedded in the leading edge of a LFMA 304 to assist the primary goal of cooking food gently with the additional goals of gentle food manipulation in either a precooked state or a cooked state.

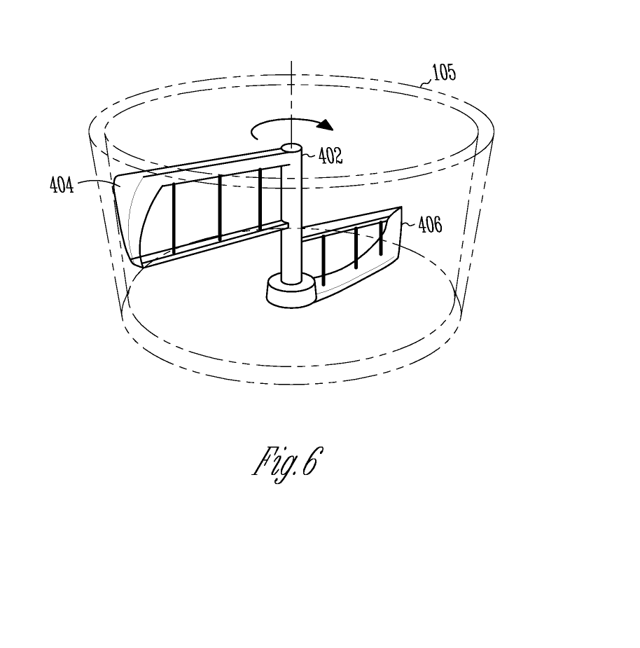

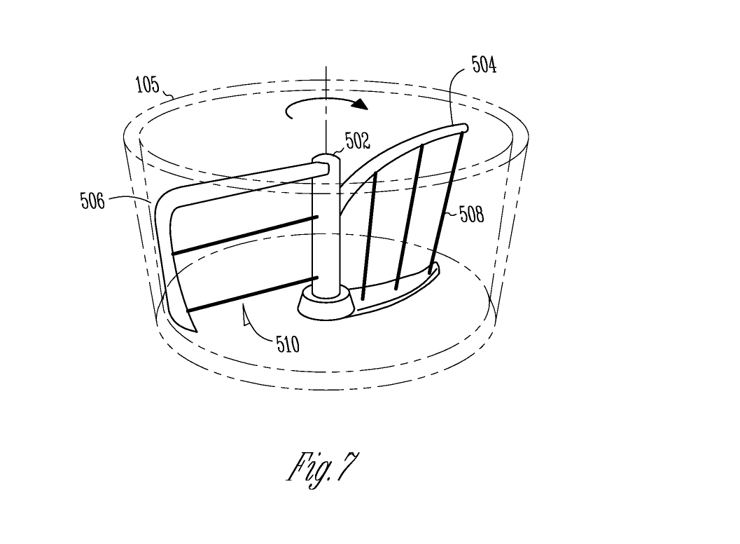

In FIGS. 6 and 7, two examples of ground meat FM (GMFM1 and GMFM2) are presented respectively. The GMFM1 402 is shown in FIG. 6, in this instance of the solution. The first GMFM1 402 has a double FMA configuration, the first GMFMA 404 and the second GMFMA 406. The first GMFMA 404 moves and sizes ground meat and moves larger portions of meat downward to interact with the second GMFMA 406. The second GMFMA 406 receives the larger portioned ground meat and continues to size and cook the ground meat. As larger portions are received, the second FMA 406 scrapes the base and then pushes the smaller cooked meat particles upwards along the sides of the cooking receptacle 105.

In FIG. 7. Another ground meat FM example is shown is the GMFM2 502. This instance of the GMFM2 design differs from FIG. 6 in the case that this GMFM2 502 addresses food sizing in a vertical and horizontal fashion rather than in a two-level agitation zone. This GMFM2 502 has a vertical sizing arm 504 that transects the food to be cooked with vertical transection wires 508 and the horizontal sizing arm 506 transects the food with horizontal transection wires 510. The transection wires (508 and 510) may have varied transection widths to help move various sized meat inwards or downwards to the next gradient of sizing.

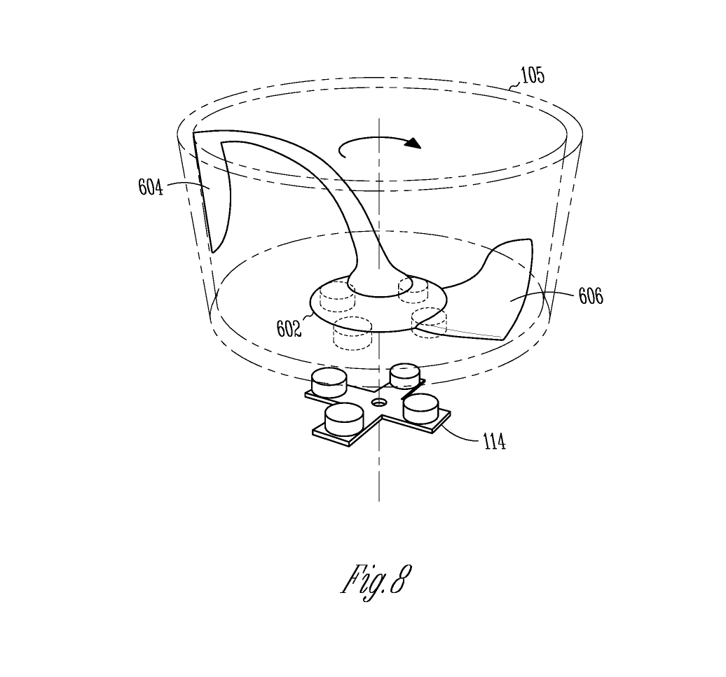

In FIG. 8, the slow stir FM (SSFM) 602 is shown connected to the magnetic hub assembly 114. This instance of the SSFM 602 is shown in a double arm configuration, with a scraping FMA 604 and an agitating FMA 606. This SSFM 602 is also shown in an inductive stirring configuration where the cooking receptacle 105 does not contain a pierced bottom to allow direct attachment of the SSFM 602 to the ADU 115. In this case, the ADU 115 is inductively coupled to the SSFM 602 and turns it without the SSFM 602 mechanical attachment to the drive unit. The scraping FMA 604 keeps the sides of the cooking receptacle 105 clean and prevents caking of dried food on the sides of the cooking receptacle 105. The agitating FMA 606 scrapes the bottom of the cooking receptacle 105 and keeps food from sticking or scorching on the base of the cooking receptacle 105. This agitating FMA 606 is especially useful in sous vide cooking to keep a sous vide package off the bottom of the cooking receptacle. As mentioned previously, the FM 602 may be heated either by inductive or resistive heating that is controlled via the control box 117 using the process of inductive heating. This is the process of heating an electrically conducting object (usually a metal) by electromagnetic induction, generating heat in the FM 602 by eddy currents (also called Foucault currents). The FM 602 with an inductive heating component comprises of an electromagnet, and an electronic oscillator that passes a high-frequency alternating current (AC) through the electromagnet. The rapidly alternating magnetic field penetrates the FM 602, generating electric currents called eddy currents in the FM 602. The eddy currents flowing through the resistance of the FM 602 and heat it by Joule heating. In the case of FM 602 comprising ferromagnetic (and ferromagnetic) materials like iron, heat may also be generated by magnetic hysteresis losses. The frequency of current used depends on the FM 602 size, material type, coupling (between the work coil and the object to be heated) and the penetration depth. An important feature of the induction heating process is that the heat is generated inside the FM 602 itself, instead of by an external heat source via heat conduction. Thus, FM 602 or cooking receptacle 105 can be heated very rapidly or uniformly. In addition, there need not be any external connection required where the integrity of cooking receptacle 105 is an issue.

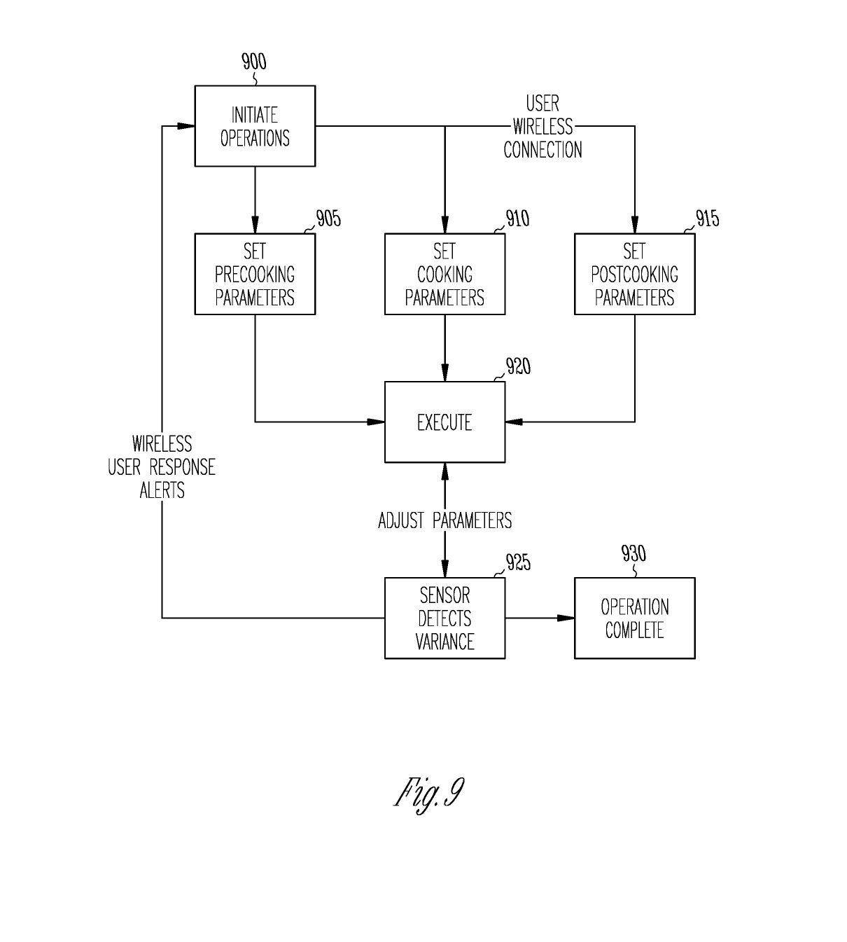

Finally, in FIG. 9, a basic operational flow chart for the solution 100 is presented. A user initiates the cooking appliance 100 in Step 900, setting precooking, cooking and post cooking parameters (Steps 905,910,915 respectively) after adding the contents to be cooked. Executing the cooking operations Step 920, with the operations monitored by the sensor unit Step 925. In the case of mobile operations, the sensor unit 162 communicates to the user via the wireless communication module, otherwise the system proceeds through the parameters as programmed to the end of operations Step 930.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific aspects of the solutions in which the invention can be practiced, they are not intended nor should they be interpreted as distinct species of the solution. These aspects of the solutions are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a solution, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An IOT example of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other of the solutions can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed of the solution. Thus, the following claims are hereby incorporated into the Detailed Description as examples or of the solutions, with each claim standing on its own as a separate example of the solution, and it is contemplated that such example of the solution can be combined with each other in various combinations or permutations. The scope of the invention should be determined with reference to the appended claims, along with the full scope of equivalents to which such claims are entitled.

The claimed invention is:

1) A cooking appliance comprising:
A housing further comprising, a cooking receptacle comprising a bottom and a continuous sidewall that forms a chamber having an open top end;
a heating element positioned for provision of heat to the cooking receptacle;
at least a food manipulator (FM) operably mounted in the cooking receptacle;
an appliance drive unit (ADU) operably connected to the FM and operably moving the FM inside the cooking receptacle;
a sensor unit operably mounted on the cooking receptacle to provide a cooking parameter; and
a controller circuit further comprising a programmable controller positioned within the housing and operatively associated with said control panel, said circuit configured to cause the heating element to operate in a plurality of cooking modes, receive a cooking parameter from the sensor unit and to allow a user to set a time and temperature of a cooking sequence and to control the motion of the FM.

2) The cooking appliance of claim 1 further comprising an FM operably connected to an ADU where the ADU moves the FM via an electromagnetic linkage using magnetic forces to move the FM inside the cooking receptacle.

3) The cooking appliance of claim 2 further comprising the FM operably moved in a pattern to keep liquids at a uniform temperature in the cooking receptacle.

4) The cooking appliance of claim 3 further comprising the FM operably designed to keep a sous vide package uniformly heated

5) The cooking appliance of claim 1 further comprising a cooling element positioned for removing heat from the cooking chamber.

6) The cooking appliance of claim 5 further comprising the cooling element utilized to maintain a food safe temperature of the contents of the cooking receptacle.

7) The cooking appliance of claim 6 further comprising the cooling element utilized to maintain the contents of the cooking receptacle at temperature of under 40 degrees Fahrenheit.

8) The cooking appliance of claim 1 further comprising a vibration element positioned to agitate and detach the food contents from the interior surface of the cooking receptacle.

9) The cooking appliance of claim 8 further comprising a cooling element positioned for removing heat from the cooking chamber.

10) The cooking appliance of claim 9 further comprising an FM operably connected to an ADU where the ADU moves the FM via a mechanical linkage to move the FM inside the cooking receptacle.

11) The cooking appliance of claim 1 further comprising an FM comprising at least a first and a second food manipulator arms (FMA)

12) The cooking appliance of claim 11 further comprising the first and second FMA having a separate purpose in food manipulation while the cooking appliance is operating.

13) The cooking appliance of claim 12 further comprising a first FMA scrapes the cooking receptacle interior and the second FMA agitates the contents of the cooking receptacle.

14) The cooking appliance of claim 12 further comprising an FMA that further comprises a force sensor that detects shear strength of the contents of the receptacle.

15) The cooking appliance of claim 12 where the cooking appliance applies more heat in response to a high value of shear from the force sensor to decrease the shear force required to move the FM.

16) A method of cooking food comprising:
adding at least a food component in an unprepared state to a cooking receptacle;
removing heat from the cooking receptacle until a preset time for cooking occurs adding heat to the food component to move the food component from an unprepared state to a prepared state; and
shearing the food component to fragment the food during the heating.

17) The method of cooking food of claim 15 further comprising removing heat from the food component reaches a prepared state.

18) The method of cooking food in claim 16 further holding the food component at a food safe temperature.
